(19) United States
(12) Patent Application Publication
(10) Pub. No.: US 2024/0413601 A1
(43) Pub. Date: Dec. 12, 2024

(54) LASER SYSTEM WITH A MULTIPASS AMPLIFIER CONFIGURED FOR THERMAL LOAD MAINTENANCE

(71) Applicant: TRUMPF Laser SE, Schramberg (DE)

(72) Inventors: Helge Hoeck, Empfingen (DE); Dominik Bauer, Rottweil (DE); Michael Scharun, Schramberg (DE); Benjamin Dannecker, Rottweil (DE); Christian Stolzenburg, Konstanz (DE); John Dominik, Dunningen (DE); Simon Nagel, Voehringen (DE)

(21) Appl. No.: 18/808,130

(22) Filed: Aug. 19, 2024

Related U.S. Application Data
(63) Continuation of application No. PCT/EP2022/084945, filed on Dec. 8, 2022.

(30) Foreign Application Priority Data
Feb. 25, 2022 (DE) 10 2022 104 529.3

(51) Int. Cl. H01S 3/23; H01S 3/00; H01S 3/04; H01S 3/06; H01S 3/08; H01S 3/10; H01S 3/102

(52) U.S. Cl. CPC H01S 3/2325; H01S 3/0014; H01S 3/04; H01S 3/0604; H01S 3/08072; H01S 3/10084; H01S 3/1022; H01S 3/1028

(57) ABSTRACT

A laser system includes a multipass amplifier for amplifying laser light and providing an amplified output beam, and a control unit. The multipass amplifier includes a laser-active medium. The control unit is configured to keep a thermal load on the laser-active medium substantially constant over a range of a laser output power of the output beam. The thermal load is determined by at least two different power sources.

### CROSS REFERENCE TO RELATED APPLICATIONS

This application is a continuation of International Application No. PCT/EP2022/084945 (WO 2023/160852 A1), filed on Dec. 8, 2022, and claims benefit to German Patent Application No. DE 10 2022 104 529.3, filed on Feb. 25, 2022. The aforementioned applications are hereby incorporated by reference herein.

### FIELD

Embodiments of the present invention relate to a laser system with a multipass amplifier for amplifying laser light. The multipass amplifier includes a laser-active medium.

### BACKGROUND

To amplify laser light radiated into a multipass amplifier, a laser-active medium is required. To achieve the population inversion in the laser-active medium that is required for amplification operation, the laser-active medium is irradiated with pump light from a pump laser with a suitable wavelength. The energy thus stored in the laser-active medium is tapped by radiating in laser light from a seed laser with a suitable wavelength (which is different from the pump light wavelength) by way of stimulated emission, as a result of which the seed laser light is amplified.

In order to increase the amplification efficiency in a laser system, it is typically desired to maximize the path length traveled by the pump radiation and/or the seed radiation within the laser-active medium. This is why so-called multipass amplifiers are used, among other things. On the one hand, pump light is guided through the laser-active medium several times by guiding the pump beam by way of a suitable optical unit geometrically through the laser-active medium. On the other hand, the seed beam and thus the laser beam to be amplified is also guided through the laser-active medium several times by way of a further suitable optical setup according to the multipass concept, before the amplified laser beam is tapped for final use. It should be noted here that with such a multipass amplifier, the seed beam is guided during its passages via geometrically different paths, in contrast to, for example, regenerative amplifiers. This has in particular the advantage that the incoupling and outcoupling within the amplifier arrangement is purely geometric and for example no optical switch is necessary for active incoupling or outcoupling, as is the case, for example, with regenerative laser amplification systems.

In general, the laser-active medium of a laser amplification system can have very different geometries and can have various advantages and disadvantages, especially depending on its aspect ratio (i.e. the ratio between depth or height of the medium and its lateral extent). Especially the optical intensities within the active media play a major role here, which can be very different for different aspect ratios. Especially at aspect ratios of significantly less than 1 (as for example in fiber laser systems), the optical intensities reach, even at comparatively low powers, very large values, which lead to non-linear behavior. Accordingly, the achievable powers are significantly influenced by the geometry of the laser-active medium.

However, the existence of thermal effects in the laser-active medium that can have a negative influence on the beam quality is independent of the geometry of the laser-active medium. In general, pump light which is not converted into laser power of the outcoupled, amplified beam generates predominantly heat, i.e. a thermal load on the laser-active medium. This thermal load is in particular relevant in multipass amplifiers, since the deposited heat output in the active medium is correspondingly high due to the multiple passage of the radiation.

This thermal load can be approximately quantified as the difference between the pump power and the extracted power, i.e. the laser output power of the laser amplification system.

Despite the typically applied cooling of the active media in laser amplification systems, the thermal load in the medium leads to undesirable thermally induced optical effects. This is in particular due to the fact that the heating owing to the pump light leads to a changed lens effect of the medium and thereby to said undesirable optical effects.

In order to nevertheless achieve constant beam parameters and a constant beam quality at a variable laser output power, previous laser amplification systems are operated with a specific, defined laser output power, which is characterized by a high beam quality. To vary the output power, downstream optical elements are used for reducing or regulating the power, instead of changing the pump power and/or seed power. This type of operation is also referred to as power point operation.

Accordingly, a laser system in power point operation requires additional components which are connected downstream to enable the desired settability of the laser output power. This increases the costs and the complexity of the system.

A regenerative disk laser amplifier is known from document DE102019131507A1, in which the pulse energy of a seed laser can be attenuated before being coupled into a resonator in order that there is no deviation in the pulse energy of the amplified output laser pulses in the event of deviations in the gain time and/or changes in the repetition rate.

With suitable attenuation of the seed laser pulse energy, which can be used to keep the pulse energy constant in the event of a change in the repetition rate due to a change in the gain time (i.e. the number of cycles of the laser beam in the resonator), however, the extracted laser power of the system also changes, as a result of which the thermal load in the active medium, here in particular a laser-active disk, changes. In order to counteract the resulting temperature change of the disk, the pump power of the system can be adapted to compensate for the thermal load change, with the result that unwanted thermally induced optical effects are suppressed.

Accordingly, the thermal load maintenance according to DE102019131507A1 is designed in such a way that the thermal load is kept constant over a range of the repetition rate of the laser pulses. However, the described system is not designed to ensure thermal load maintenance over a range of the extracted laser output power of the laser system.

### SUMMARY

Embodiments of the present invention provide a laser system that includes a multipass amplifier for amplifying laser light and providing an amplified output beam, and a control unit. The multipass amplifier includes a laser-active medium. The control unit is configured to keep a thermal load on the laser-active medium substantially constant over a range of a laser output power of the output beam. The thermal load is determined by at least two different power sources.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a laser system with a multipass amplifier with various power sources that contribute to the thermal load of the laser-active medium according to some embodiments.

### DETAILED DESCRIPTION

Embodiments of the present invention provide an improved laser system for amplifying laser light, which provides an almost constant beam quality as well as beam parameters over a range of the laser output power.

According to some embodiments, a laser system is includes a multipass amplifier, in particular a multipass disk laser amplifier, for the amplification of laser light to provide an amplified output beam, and a control unit, wherein the multipass amplifier comprises a laser-active medium. According to embodiments of the invention, the control unit is configured to keep the thermal load on the laser-active medium, which is determined by at least two different power sources, substantially constant over a range of the laser output power of the output beam.

The active medium of the multipass amplifier may be disk-shaped, with a disk-shaped active medium including all those shapes in which the lateral dimensions are significantly larger than their thicknesses. However, a disk-shaped active medium also comprises one and/or more transmissive disks, which may be coated on one side or on both sides with an antireflective coating. The active medium of the multipass amplifier also does not have to have a disk shape, but can also have other geometries.

The thermal load of a laser-active medium of a laser system with a multipass amplifier is primarily determined by the pump power of the pump laser used and the seed power of the seed laser, which are configured for irradiating the laser-active medium. The pump radiation that is absorbed in the laser-active medium, but is not extracted by way of the stimulated emission induced by the seed radiation in the laser-active medium is deposited in the laser-active medium dominantly as heat. If a first consideration is restricted to these power sources necessary for the laser amplification (pump power and seed power), without excluding other power sources which lead to a heat input and/or a heat dissipation into/from the laser-active medium, the thermal load Pth of the laser-active medium can be approximated as

$$Pth = Ppump - {P}_{ex} = Ppump - K ( Ppump ) Pseed ,$$

where Ppump is the pump power of the pump laser and P ex is the extracted power of the amplified laser output beam. The latter is referred to below as laser output power. After the second equals sign, P ex=K(Ppump) Pseed was used. The laser output power P ex is thus directly proportional to the seed power Pseed, where the proportionality factor K(??Pump) is the amplification factor, which in turn is a function of the pump power Ppump. The specific functional relationship between the amplification factor K and the pump power Ppump depends substantially on the energy level structure of the laser-active laser medium used. In general, however, it may be noted that the amplification factor K increases as the pump power Ppump increases as long as the laser-active medium is not destroyed by too high a pump power and/or changes its properties in such a way that normal laser operation is no longer possible.

From the above considerations and the equation for the thermal load it is clear that an increase in the pump power, depending on the (constant) seed power 1seed used and the present amplification factor K, can either result in an increase or a decrease in the thermal load 1ₜh.

For common amplification factors K and typically used seed powers 1Seed, however, it should be assumed that an increase in the pump power 1pump also leads to an increase in the thermal load 1ₜh.

An increase in the seed power 1seed, in turn, at finite (constant) pump power 1pump typically leads to a decrease in the thermal load 1ₜh as long as there is no saturation of the amplification by the seed power.

Preferably, the range of the laser output power extends over the complete range of the achievable laser output powers of the multipass amplifier or extends only over a part of this range. In other words, the thermal load can be kept substantially constant over a specified range of output powers, such that elements connected downstream for power regulation can be dispensed with and a high beam quality can be maintained at the same time.

In particular, a repetition rate of laser pulses of the output beam is constant. Preferably, the repetition rate of the laser pulses of the output beam is constant over that range of the laser output power of the output beam over which the thermal load on the laser-active medium is kept substantially constant by means of the control unit.

In particular, the repetition rate of the laser pulses of the output beam is not varied over the range of the laser output power of the output beam.

The term “keeping substantially constant” the thermal load on the laser-active medium is understood herein to mean that the thermal load has a maximum relative fluctuation of ±10%, preferably ±5%, more preferably ±2%.

However, embodiments of the present invention are not limited in the above examples with regard to the change in thermal load due to changes in the seed power and pump power. Rather, any other change in the thermal load 1ₜh which is induced by a change in the seed power 1seed and/or the pump power 1pump is also included.

Furthermore conceivable are further power sources, in addition to the seed power and the pump power, which make a (positive or negative) contribution to the thermal load of the laser-active medium and also can have a direct influence on the laser output power.

Embodiments of the present invention utilize in particular the specific relationship between the thermal load Pₜh and the seed power and pump power in order to keep the thermal load substantially constant over a range of the laser output power by appropriately adapting the seed power and pump power. This makes possible a laser system with which a variable laser output power is realized while the thermal load is constant. The latter in particular improves the usability of the amplified output beam, as its beam quality and beam parameters can be kept almost constant over the entire range of the laser output power via the thermal load maintenance.

Accordingly, a seed laser and a pump laser are preferably provided as power sources contributing to the thermal load on the laser-active medium, with the seed and pump lasers being used for irradiating the laser-active medium, wherein the control unit is configured to adapt a seed power of the seed laser and a pump power of the pump laser together over the range of the laser output power in such a way that the thermal load on the laser-active medium is substantially constant.

Preferably, the control unit is configured to keep the thermal load on the laser-active medium substantially constant over the range of the laser output power by adapting the outputs from the power sources contributing to the thermal load of the laser-active medium by way of manual setting and/or by way of a mathematical model and/or by way of an assignment table.

Preferably, the control unit is configured to keep the beam quality and/or at least one beam parameter of the output beam, preferably defined by the waist diameter and/or the waist position and/or M squared, substantially constant over the range of the laser output power, wherein preferably the beam quality and/or the beam parameter has, over the range of the laser output power, a maximum relative fluctuation of ±10%, preferably ±5%, preferably ±2%.

Here, the beam parameters are mainly given by the waist diameter and the waist position, wherein the beam quality is characterized primarily by M squared of the amplified output beam.

Preferably, a monitoring device for monitoring the beam quality and the beam parameters, in particular the waist diameter, the waist position and M squared of the amplified output laser beam can be provided.

In a further preferred embodiment, the pump laser is configured to generate an extensive, blurred pump spot on the laser-active medium. In this way, a more homogeneous behavior of the laser-active medium can be achieved, with which the beam quality can be further improved.

Preferably, the pump laser is configured to generate a pump spot on the laser-active medium, the diameter of which is greater by a factor of 1 to 1.5 than the diameter of the seed beam or, if a plurality of seed beams are incident on the laser-active medium, of the seed spot resulting from the seed beams on the laser-active medium. This can prevent or reduce the fact that marginal regions of the pumped volume have an influence on the beam quality, so that the beam quality can be further improved.

Preferably, a temperature measurement unit is provided, which is configured to determine the thermal load of the laser-active medium by measuring the temperature of the active medium. In this way, the act of keeping the thermal load constant can be monitored. The temperature measurement unit can also be provided for regulating the power sources in such a way that the thermal load is kept substantially constant.

In addition to the seed power and pump power, external power sources can also be used for thermal load maintenance of the laser-active medium of the laser amplification system. Unlike seed power and pump power, these power sources do not directly influence the laser output power of the laser system, but have a direct influence on the thermal load. For the sake of accuracy, however, it should be noted that an indirect influence on the laser output power is also induced by the change in temperature of the laser-active medium brought about by the thermal load. However, this effect should be neglected.

In particular, means for cooling, i.e. for heat dissipation from the laser-active medium, can be used. Accordingly, a cooling unit may be provided, which as a heat sink can reduce the thermal load of the laser-active medium. The corresponding cooling power of the cooling unit, which is discharged from the medium, can be quantified as [symbol] . For example, a water cooling system which is in thermal contact with the laser-active medium can be used. Any other method which provides a cooling power [symbol] for the laser-active medium is also suitable.

Furthermore, means for heating, i.e. for the heat input into the laser-active medium, can be used. Accordingly, a heating element which as a heat source can increase the thermal load of the laser-active medium can be provided. The corresponding heating power of the heating element which is input into the medium can be quantified as ‘heiz.

For example, a radiant heater can be used, which is directed at the laser-active medium. Any other method which provides a heating power ‘heiz for the laser-active medium is also suitable.

Preferably, the power sources contributing to the thermal load of the laser-active medium can correspondingly include the cooling power of a cooling unit configured for cooling the laser-active medium and/or the heating power of a heating element configured for heating the laser-active medium, which have no direct influence on the laser output power of the output beam.

Preferably, the control unit is configured to adapt, at a constant seed power and changing pump power, the heating power of the heating element and/or the cooling power of the cooling unit in such a way that the thermal load on the laser-active medium is substantially constant over the range of the laser output power or to adapt, at constant pump power and changing seed power, the heating power of the heating element and/or the cooling power of the cooling unit in such a way that the thermal load on the laser-active medium is substantially constant over the range of the laser output power, or to adapt, at maximum pump power and changing seed power, the pump power effectively irradiating the laser-active medium by means of targeted outcoupling of pump power using an auxiliary resonator and/or an absorber, in such a way that the thermal load on the laser-active medium is substantially constant over the range of the laser output power.

To quantify the thermal load of the laser-active medium, a temperature measurement unit that can measure the temperature of the laser-active medium can additionally be provided. For example, the temperature measurement unit may be an infrared thermal camera directed at the active medium. Any other apparatus suitable for measuring the temperature of the laser-active medium is also included.

The range of the laser output power over which the thermal load of the medium is kept constant can extend either over the entire laser output power achievable by the system or merely over a portion of this range. In other words, the range can be any desired range, where the beam quality is still maintained.

A control unit is provided for adapting the power sources contributing to the thermal load of the laser-active medium, in particular the power variables ‘pump, ‘seed, ‘kühl and ‘heiz, the control unit adapting the power sources for thermal load maintenance according to an appropriate rule.

In a preferred embodiment, the control unit can be configured to adapt the seed power ‘seed and the pump power [symbol] simultaneously over a range of the laser output power of the laser system in such a manner that the thermal load on the laser-active medium is constant, with the heating power of the heating element and the cooling power of the cooling element being zero or constant. Preferably, the cooling power can be constant while the heating power is zero, so that the thermal load on the laser-active medium is kept constant, but as low as possible.

For the typical case in which an increase/decrease in the pump power ‘pump also results in an increase/decrease in the thermal load ‘ₜh, and an increase/decrease of the seed power ‘seed in turn leads to a decrease/increase in the thermal load ‘ₜh, the powers ‘pump and ‘seed can be increased/decreased simultaneously so that the laser output power continuously rises/falls, while the thermal load remains constant. In this case, no additional adaptation of the heating and/or cooling power is necessary. In a preferred embodiment, however, the laser-laser-active medium is nevertheless cooled by the cooling unit with a constant cooling power to reduce thermally induced optical effects with negative influence on the beam quality, or even to prevent a thermally induced destruction of the laser-active medium.

In an alternative embodiment, the thermal load maintenance can be effected by means of the control unit even at a constant seed power. Accordingly, only the pump power can be increased/decreased to continuously increase/decrease the laser output power. The resulting change in thermal load can be compensated for by appropriately adapting the heating power of the heating element and/or the cooling power of the cooling unit.

In a typical example, increasing/decreasing the pump power at constant seed power would also result in an increase/decrease in the thermal load, which can be compensated for by appropriately increasing/decreasing the cooling power of the cooling unit and/or by decreasing/increasing the heating power of the heating element.

In a further alternative embodiment, the thermal load maintenance can be effected by means of the control unit even at a constant pump power. Accordingly, only the seed power may be increased/decreased to continuously increase/decrease the laser output power. The resulting change in thermal load can be compensated for by appropriately adapting the heating power of the heating element and/or the cooling power of the cooling unit.

In a typical example, the increase/decrease in seed power at a constant pump power lead to a decrease/increase in thermal load, which can be compensated for by an appropriate increase/decrease in the heating power of the heating element and/or by a decrease/increase in the cooling power of the cooling unit.

In a further embodiment, the thermal load maintenance can be effected by means of the control unit even at maximum (constant) pump power. Accordingly, only the seed power may be increased/decreased to continuously increase/decrease the laser output power. The resulting decrease/increase in the thermal load can be compensated for by appropriately outcoupling the radiated pump power by means of an auxiliary resonator, so that the thermal load in the laser-active medium is constant. Instead of an auxiliary resonator, an absorber which can compensate for the aforementioned decrease/increase in the thermal load could also be used.

The control unit can keep the powers of the power sources contributing to the thermal load of the laser-active medium constant by manual setting and/or by a mathematical model and/or by an assignment table.

When manually adapting the power sources, the control unit can be implemented by an expert operator of the laser system. The operator can set the powers contributing to the thermal load according to the abovementioned embodiments in such a way that the thermal load is constant over a range of the laser output power.

Alternatively, a control unit can use a mathematical model to calculate the powers contributing to the thermal load in such a way that the thermal load is constant over a range of the laser output power. For this purpose, a functional dependence of the thermal load Pₜh on the power sources contributing to the thermal load must be known as precisely as possible, in particular its dependence on seed power and pump power. A mathematical model of this kind can be used, for example, via software in an electronic control unit, for example a computer, which is connected to the power sources contributing to the thermal load in the laser system and can control them accordingly. For example, at a specified laser output power, the electronic control unit can specify the powers contributing to the thermal load in accordance with the aforementioned embodiments by means of a real-time calculation and keep them constant over the range of the laser output power by controlling the power sources.

A further alternative to thermal load maintenance by way of a control unit can be achieved by a previously created assignment table. The assignment table is characterized in that: suitable values for the powers contributing to the thermal load are specified for a specified laser output power, which values lead to a thermal load maintenance over the range of the laser output power. For example, the assignment table can be pre-calculated or determined empirically.

For example, an electronic control unit can be used, for example, a computer that uses the previously created assignment table to control the power sources in accordance with the aforementioned embodiments and thus to keep the thermal load constant over the range of the laser output power.

Using the inventive control unit for thermal load maintenance on the laser-active medium over a range of the laser output power, the thermally induced optical effects (in particular the altered lens effect of the laser-active medium) discussed in the introductory part are kept at an almost constant level. Accordingly, the beam quality and the beam parameters of the amplified output beam, in particular its waist diameter, waist position and M squared will also remain almost constant, but at least more constant than a laser system without thermal load maintenance.

In particular, the maximum relative fluctuation in said values for the beam quality or beam parameters corresponds to a maximum of ±10%, preferably ±5%, preferably ±2%.

In order to quantitatively check the beam quality and beam parameters, the laser amplification system can include a monitoring device for monitoring the beam quality and the beam parameters of the amplified output laser beam. For example, the beam quality and beam parameters can be monitored by a CCD camera, into which a part of the output beam can be coupled. Alternative apparatuses for measuring the beam quality and beam parameters are not excluded here.

The object described above is also achieved by a method of amplifying a seed laser beam having the features of claim 12.

Accordingly, a method for amplifying a seed laser beam in a multipass amplifier comprising a laser-active medium is proposed to provide an amplified output beam. According to embodiments of the invention, the thermal load on the laser-active medium, which is determined by at least two different power sources, is kept substantially constant over a range of the laser output power, with the thermal load on the laser-active medium preferably being kept constant in a range of ±10%, preferably ±5%, preferably ±2%.

Preferably, the laser sources contributing to the thermal load of the laser-active medium include the seed power of a seed laser and the pump power of a pump laser, which are configured to irradiate the laser-active medium, wherein the seed power of the seed laser and the pump power of the pump laser over the range of the laser output power are adapted together in such a way that the thermal load on the laser-active medium is kept substantially constant.

Preferably, the thermal load on the laser-active medium is kept substantially constant by adapting the powers of the power sources contributing to the thermal load of the laser-active medium by manual setting and/or by a mathematical model and/or by an assignment table.

The beam quality and/or at least one beam parameter of the output beam, in particular defined by the waist diameter and/or the waist position and/or M squared, is preferably kept substantially constant, wherein preferably the beam quality and/or the beam parameter has, over the range of the laser output power, a maximum relative fluctuation of ±10%, preferably ±5%, preferably ±2%.

In the following text, preferred exemplary embodiments are described using the figure.

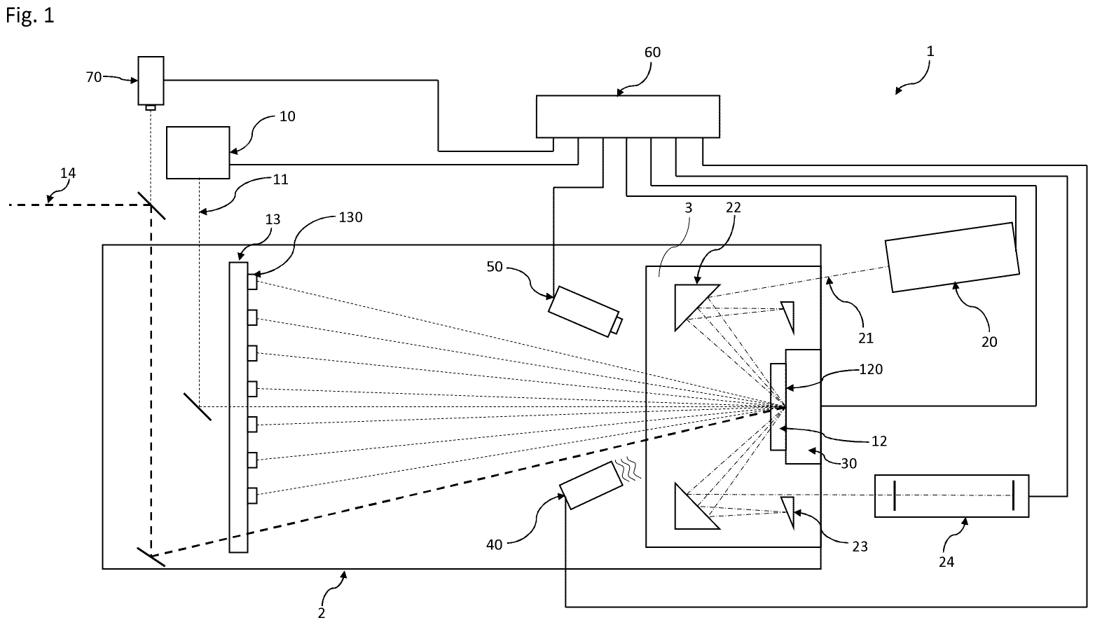

FIG. 1 schematically illustrates a laser system 1, which comprises a multipass amplifier 2 in the form of a multipass disk laser amplifier. The multipass amplifier 2 comprises a laser-active medium 12 and is used to amplify laser light to provide an amplified output beam 14.

The laser system 1 has a seed laser 10 and a pump laser 20, whose corresponding seed laser beam 11 and pump laser beam 21, respectively, are coupled into the multipass amplifier 2.

The laser-active medium 12 can be provided as a disk laser. Disk lasers are solid-state lasers with a laser-active medium in the form of a disk. Typically, these disks are coated on the rear side with a highly reflective layer, and therefore at the same time serve as a mirror. Thus, a laser beam that is incident on the disk is guided twice through the laser-active medium due to the rear-side reflection.

In general, the disk of a disk laser comprises all those geometric shapes in which the lateral dimensions are significantly larger than their thicknesses. This makes possible in particular more efficient cooling of the laser-active medium 12, since a heat sink can be applied on the side of the reflective layer over the relatively large lateral extent thereof. In addition to this efficient cooling, the special shape of the laser-active medium 12 of a disk laser enables heat dissipation with a temperature gradient that is almost exclusively perpendicular to the lateral extent. This results in a decrease of the thermal effects on the disk occurring during operation, which can have a negative effect on beam quality.

Although the simple irradiation of a laser-active disk with a reflective layer on the rear side already results in a twofold pass of radiation through the laser-active medium, the absorption of incoming laser light is typically still relatively low due to the small thickness of the laser-active disk. To improve the amplification, therefore, as already described in the introductory part, so-called multipass amplifiers 2 are constructed, among other things, which through suitable optical structures guide a pump beam and also a seed beam several times through the disk. However, the latter also results in a higher thermal load on the disk.

Despite cooling, this thermal load on the disk leads to undesirable thermally induced optical effects. This is due in particular to the fact that the heating by the pump light is relatively localized and inhomogeneous on the region of the disk (“pump spot”) irradiated by the pump light. Associated local changes and inhomogeneities of the temperature lead to a changed lens effect of the disk and thus to said undesirable optical effects.

These effects include a geometric curvature of the front side of the disk caused by the pump spot. This curvature changes the propagation of the (seed) laser beam and thus beam parameters and possibly a decrease of the beam quality.

Furthermore, the local temperature change on the disk leads to a change in the density of the laser-active material of the disk and thus to a change in the local refractive index of the disk material. This in turn involves a change in the optical properties of the disk, resulting in changed beam parameters and potentially a deterioration of the beam quality.

A further effect is the generation of a thermal gas lens, which is induced by the heating of the surrounding gas in front of the laser-active disk. The density change due to the increased temperature of the gas affects the local refractive index distribution in front of the disk, and the propagation of the seed beam is in turn influenced undesirably.

In the exemplary arrangement of FIG. 1, a laser-active medium 12 in the form of the laser-active disk is attached to the right end of the multipass amplifier 2, the laser-active medium having a highly reflective layer 120 applied on the rear side. Preferably, the laser-active medium 12 is in thermal contact on the rear side with a cooling unit 30, so that laser radiation-induced heat can be dissipated. For example, the cooling unit 30 can be a water cooling unit.

In particular, the multipass amplifier 2 has suitable optical apparatuses for the geometric folding of the laser beams 11 and 21. In the example shown, the multipass amplifier 2 has a pump optical unit 3, which comprises, for example, a parabolic mirror 22 and retroreflectors 23. After coupling the pump laser beam 21 into the multipass amplifier 2, the pump laser beam 21 is guided to the parabolic mirror 22, which in turn reflects the pump laser beam 21 back onto the laser-active medium 12.

The pump laser beam 21 incident on the highly reflective layer 120 is in turn guided to the parabolic mirror 22, whereupon the beam 21 is incident on a retroreflector 23. The retroreflector 23 reflects the pump laser beam 21 back onto the parabolic mirror 22, so that a further passage through the laser-active medium 12 takes place. With a plurality of appropriately arranged retroreflectors 23 it is thus possible to achieve numerous passages through the laser-active medium 12, as a result of which the effectively traveled path of the pump radiation 21 in the laser-active medium 12 and the associated effectively input absorbed pump power is increased.

In a typical exemplary design, the pump optical unit 3 may also have an end mirror (not shown in FIG. 1), on which the pump laser beam 21 is incident after it has made multiple passes through the laser-active medium 12 and is arranged such that the pump beam propagates back the entire path via the laser-active medium 12, the parabolic mirror 22, and the retroreflectors 23.

In a further optional embodiment, the pump optical unit 3 can also provide an auxiliary resonator 24 in the beam path of the pump laser beam 21 instead of an end mirror. This auxiliary resonator can be used to couple some of the pump power of the pump laser beam 21 out and thus represents a setting option for the pump power effectively input into the laser-active medium 12.

In a further optional embodiment, the pump optical unit 3 can also provide an absorber (not shown in FIG. 1) in the beam path of the pump laser beam 21, instead of an end mirror or an auxiliary resonator 24. This absorber can likewise be used to couple some of the pump power of the pump laser beam 21 out and thus represents a further setting possibility for the pump power effectively input into the laser-active medium 12.

Furthermore, in the exemplary embodiment under discussion, the multipass amplifier 2 comprises a mirror arrangement 13 having a plurality of individual mirrors 130 in a special arrangement. After coupling the seed laser beam 11 into the multipass amplifier 2, the seed laser beam 11 is guided via the mirror arrangement 13 to the laser-active medium 12. Owing to the highly reflective layer 120 on the rear side of the laser-active medium 12, the incoupled seed laser beam 11 is reflected back onto the mirror arrangement 13 and is incident on one of the mirrors 130. The mirrors 130 are designed in such a way that the seed laser beam 11 is reflected back onto the disk 12. Using a multiplicity of suitably designed mirrors 130,

numerous passes of the seed laser beam 11 through the disk 12 can thus be achieved, as a result of which the laser amplification is increased with each pass. Accordingly, after the last passage of the seed laser beam 11 through the laser-active medium 12, the amplified output laser beam 14 is coupled out of the mirror arrangement 13 and out of the multipass amplifier 2.

The multiple passes of the seed laser beam 11 and the pump laser beam 21 through the laser-active medium 12 primarily provide the heat input in and the heat dissipation from the laser-active medium 12. Accordingly, the heat input or the thermal load in the laser-active medium 12 can be influenced by setting the pump power of the pump laser 20 and the seed power of the seed laser 10.

According to embodiments of the invention, further laser power sources which, in addition to the seed laser 10 and the pump laser 20, apply laser power to the laser-active medium 12 and thereby introduce heat into the laser-active medium 12 and/or dissipate it from the laser-active medium 12 can be taken into account for setting the thermal load of the laser-active medium 12.

Further power sources that may lead to a change in the heat input of the laser-active medium 12 are, for example, the cooling power of a cooling unit 30, for example water cooling, and/or the heating power of a heating element 40, for example a radiant heater, which is directed at the laser-active medium 12.

In contrast to the laser powers, i.e. the seed power and the pump power, the cooling power and heating power do not directly affect the laser output power of the amplified output beam 14. An indirect influence can be caused by the thermally induced optical effects on the laser-active medium 12 or by the temperature change of the laser-active medium 12, which, however, have a comparatively insignificant influence on the output power. Any further power sources that can lead to heat input into or heat dissipation from the disk 12 and thereby have no direct influence on the output power of the output beam 14 can be used for thermal load maintenance of the laser-active medium 12.

For measuring the thermal load of the laser-active medium 12, a temperature measurement unit 50 may also be provided, for example in the form of an infrared thermal camera.

By determining the temperature of the laser-active medium 12 via the thermal camera, conclusions can be drawn about the thermal load of the laser-active medium 12.

A control unit 60 is provided, which is configured to set two or more of the thermal power sources mentioned above, which influence the thermal load of the laser-active medium 12, in such a way that the thermal load on the laser-active medium 12 is substantially constant over a range of the laser output power of the amplified output laser beam 14.

A substantially constant thermal load of the laser-active medium 12 is understood herein to mean in particular a thermal load which has a relative fluctuation in the values of ±10%, preferably ±5%, preferably ±2%.

This makes it possible to achieve a substantially constant beam quality and/or at least one substantially constant beam parameter of the output laser beam 14 over the range of the laser output powers. In particular, essential parameters which represent the beam quality and the beam parameters, such as the waist diameter, the waist position, and M squared, can be kept substantially constant over a range of the laser output power via the inventive thermal load maintenance.

A substantially constant development of the beam quality and/or of a beam parameter over a range of the laser output power can be quantified by a relative fluctuation in these values of ±10%, preferably ±5%, preferably ±2%. These values relate in particular to the waist diameter, the waist position, and M squared of the output beam 14.

The connecting lines connected to the control unit 60, which, among other things, connect the seed laser 10, the pump laser 20, the cooling unit 30, the heating element 40, and the temperature measurement unit 50 to the control unit 60, show in FIG. 1 that the aforementioned elements can be set appropriately. Accordingly, the power sources contributing to the thermal load of the laser-active medium 12 in the embodiment shown in FIG. 1, for example, are set manually such that for any laser output power of the amplified output beam 14, the thermal load of the laser-active medium 12 is kept substantially constant. An operator can check that the thermal load is kept constant by means of the temperature measurement unit 50 for each output power of the laser output beam 14.

Alternatively, the control unit 60 may be provided in the form of a computer, a computer program product, or a programmable controller. Using such an electronic controller, the thermal load maintenance can be effected, for example, via a mathematical model implemented in the control unit 60. The latter includes all power sources contributing to the thermal load of the laser-active medium 12 and calculates the theoretically expected thermal load from the values. The desired laser output power and a fixed value of the thermal load which remains unchanged over any range of the laser output power serve as input parameters. The other power sources are then calculated in such a way that the thermal load remains constant for any laser output powers.

Alternatively, electronic control can also be implemented via an assignment table. For this purpose, an empirically determined or previously calculated table is generated, which provides for a defined thermal load on the laser-active medium 12 suitable values for the power sources contributing to the thermal load of the laser-active medium 12 to achieve the desired value of the thermal load. These values are generated for a series of laser output powers of the output beam 14, so that the electronic control unit 60 can access the values when the desired output power is set and set the corresponding power sources, specifically in such a way that the thermal load remains constant over any range of the laser output power. For example, for a desired laser output power, a seed power and a pump power are specified and set accordingly for the seed laser 10 and the pump laser 20.

Compared with the previously described alternative using a mathematical model, a previously created assignment table for thermal load maintenance can be advantageous, since the electronic control unit 60 in the latter case does not have to perform a real-time calculation, but may simply access the pre-calculated values of the table. Accordingly, this can lead to advantages in terms of the speed of the appropriate setting of the power parameters by the control unit 60.

The control unit 60 can also regulate the pump power of the pump laser 20 and the seed power of the seed laser 10 to a specified temperature value via a controller, for example a PID controller, based on the values measured by means of the temperature measurement unit 50.

To check the beam quality and beam parameters of the laser output beam 14, a monitoring device 70 is furthermore provided, for example in the form of a CCD camera. The monitoring device 70 is preferably configured to measure the waist diameter, the waist position, and M squared of the amplified output beam 14. For this purpose, for example, a part of the output beam 14 can be outcoupled (e.g. via a partially transparent mirror) in order to be coupled into the monitoring device 70 and measured by it. Further measurements of beam parameters are not excluded. Moreover, a connection of the monitoring device 70 to the control unit 60 is provided, by way of which, for example, a skilled operator or an electronic control unit such as a computer can check the beam quality. In particular, the monitoring device 70 can offer a possibility for checking the constancy of the beam quality and of the beam parameters over any range of the laser output power.

The beam quality and the beam parameters are preferably substantially constant over the entire range of the laser output power owing to the thermal load maintenance of the laser-active medium 12.

Exemplary methods for thermal load maintenance over a range of the laser output power based on the laser system 1 shown in FIG. 1 are described above.

In a preferred embodiment of the laser system 1 according to FIG. 1, a reduction in the thermal load can be achieved by the pump laser 20 generating a blurred, extensive pump spot on the laser-active medium 12, as a result of which the beam quality of the amplified output beam 14 is improved due to the reduction of undesirable thermal effects on the laser-active medium 12.

In an equally preferred embodiment of the laser system 1 having a multipass amplifier, the amplification efficiency can be increased by the diameter of the pump beam 21 on the laser-active medium 12 corresponding at least to the diameter of the seed beam 11 on the laser-active medium 12 or, when a plurality of seed beams are incident on the laser-active medium 12, of the seed spot resulting from the seed beams. In particular, the diameter of the pump beam 21 can have an extent which is greater by a factor of 1 to 1.5 than the diameter of the seed beam 11 or the diameter of the seed spot.

Insofar as applicable, all individual features presented in the exemplary embodiments may be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser system
2 Multipass amplifier (multipass disk laser amplifier)
3 Pump optical unit
10 Seed laser source
11 Seed laser beam
12 Laser-laser-active disk of the multipass amplifier
120 Highly reflective layer
13 Mirror arrangement of the multipass amplifier
130 Mirror of the mirror arrangement
14 Output laser beam
20 Pump laser
21 Pump laser beam
22 Parabolic mirror for pump optical unit
23 Retroreflector
24 Auxiliary resonator
30 Cooling unit
40 Heating element
50 Temperature measurement unit
60 Control unit
70 Device for monitoring beam quality

1. A laser system comprising:
a multipass amplifier for amplifying laser light and providing an amplified output beam, and
a control unit,
wherein the multipass amplifier comprises a laser-active medium, the control unit is configured to keep a thermal load on the laser-active medium substantially constant over a range of a laser output power of the output beam, wherein the thermal load is determined by at least two different power sources.

2. The laser system as claimed in claim 1, wherein the multipass amplifier comprises a multipass disk laser amplifier.

3. The laser system as claimed in claim 1, wherein the range of the laser output power extends over an entire range of achievable laser output powers of the multipass amplifier or extends over only a part of the entire range, and/or the control unit is configured to keep the thermal load on the laser-active medium constant in a range of ±10%.

4. The laser system as claimed in claim 1, wherein the control unit is configured to keep the thermal load on the laser-active medium constant in a range of ±5%.

5. The laser system as claimed in claim 1, wherein the control unit is configured to keep the thermal load on the laser-active medium substantially constant over the range of the laser output power by adapting powers of the at least two power sources contributing to the thermal load of the laser-active medium by manual setting and/or by a mathematical model and/or by an assignment table.

6. The laser system as claimed in claim 1, wherein a seed laser and a pump laser are provided as the at least two power sources contributing to the thermal load on the laser-active medium, wherein the seed laser and the pump laser are configured to irradiate the laser-active medium, wherein the control unit is configured to adapt a seed power of the seed laser and a pump power of the pump laser together over the range of the laser output power so that the thermal load on the laser-active medium is substantially constant.

7. The laser system as claimed in claim 1, wherein the control unit is configured to keep a beam quality and/or at least one beam parameter of the output beam substantially constant over the range of the laser output power, so that the beam quality and/or the beam parameter has, over the range of the laser output power, a maximum relative fluctuation of ±10%.

8. The laser system as claimed in claim 7, wherein the beam quality or the at least one beam parameter of the output beam comprises at least one of a waist diameter, a waist position, or M squared.

9. The laser system as claimed in claim 7, further comprising a monitoring device for monitoring the beam quality and/or the at least one beam parameter of the amplified output laser beam.

10. The laser system as claimed in claim 6, wherein the pump laser is configured to generate an extensive blurred pump spot on the laser-active medium.

11. The laser system as claimed in claim 6, wherein the pump laser is configured to generate a pump spot on the laser-active medium, wherein a diameter of the pump spot is greater by a factor of 1 to 1.5 than a diameter of a seed spot on the laser-active medium generated by the seed laser.

12. The laser system as claimed in claim 1, further comprising a temperature measurement unit configured to determine the thermal load of the laser-active medium by measuring a temperature of the laser-active medium.

13. The laser system as claimed in claim 1, wherein the at least two power sources contributing to the thermal load of the laser-active medium comprise a cooling unit configured to cool the laser-active medium and/or a heating element configured to heat the laser-active medium, wherein a cooling power of the cooling unit and a heating power of the heating element have no direct influence on the laser output power of the output beam.

14. The laser system as claimed in claim 13, wherein the control unit is configured to:
adapt, at a constant seed power and a changing pump power, the heating power of the heating element and/or the cooling power of the cooling unit so that the thermal load on the laser-active medium is substantially constant over the range of the laser output power, or
adapt, at a constant pump power and a changing seed power, the heating power of the heating element and/or the cooling power of the cooling unit so that the thermal load on the laser-active medium is substantially constant over the range of the laser output power, or
adapt, at a maximum pump power and the changing seed power, an effective pump power effectively irradiating the laser-active medium by targeted outcoupling of a pump power by using an auxiliary resonator and/or an absorber so that the thermal load on the laser-active medium is substantially constant over the range of the laser output power.

15. A method for amplifying a seed laser beam in a multipass amplifier comprising a laser-active medium, the method comprising:
amplifying the seed laser beam using the multipass amplifier to provide an amplified output beam, and
keeping a thermal load on the laser-active medium substantially constant over a range of a laser output power, wherein the thermal load is determined by at least two different power sources, and wherein the thermal load on the laser-active medium is kept constant in a range of ±10%.

16. The method as claimed in claim 15, wherein the at least two power sources contributing to the thermal load of the laser-active medium include a seed laser and a pump laser, wherein the seed laser and the pump laser are configured to irradiate the laser-active medium, wherein a seed power of the seed laser and a pump power of the pump laser over the range of the laser output power are adapted together so that the thermal load on the laser-active medium is kept substantially constant.

17. The method as claimed in claim 15, wherein the thermal load on the laser-active medium is kept substantially constant by adapting powers of the at least two power sources contributing to the thermal load of the laser-active medium by manual setting, and/or by a mathematical model, and/or by an assignment table.

18. The method as claimed in claim 15, further comprising a beam quality and/or at least one beam parameter of the output beam substantially constant, over the range of the laser output power, with a maximum relative fluctuation of ±10%.

19. The method as claimed in claim 18, wherein the beam quality or the at least one beam parameter of the output beam comprises at least one of a waist diameter, a waist position, or M squared.
